(19) United States
(12) Patent Application Publication
(10) Pub. No.: US 2025/0355075 A1
(43) Pub. Date: Nov. 20, 2025

(54) SYSTEM FOR ACQUIRING INFORMATION ON A PREDEFINED MONITORED ZONE

(71) Applicant: SICK AG, Waldkirch (DE)

(72) Inventor: Jan OTTMÜLLER, Hamburg (DE)

(21) Appl. No.: 19/209,217

(22) Filed: May 15, 2025

(30) Foreign Application Priority Data
May 17, 2024 (DE) 102024113954.4

(51) Int. Cl. G01S 7/00; G01S 17/87

(52) U.S. Cl. CPC G01S 7/003; G01S 17/87

(57) ABSTRACT

The present invention relates to a system for acquiring information on a predefined monitored zone. The system comprises at least two sensor units, each having at least one sensor, at least one actuator for varying the orientation and/or position of the at least one sensor, and at least one control unit for controlling the at least one actuator. Each sensor unit comprises an internal clock. The times of the different sensor units are synchronized with one another. The control unit of each sensor unit is configured to perform the control of the associated actuator or actuators based on the synchronized time of the respective internal clock.

The present invention relates to a system for acquiring information on a predefined monitored zone and to a corresponding method.

Conventionally, such systems comprise at least two sensor units, each having at least one sensor, at least one actuator for varying the orientation and/or position of the at least one sensor, and at least one control unit for controlling the at least one actuator.

In this respect, it may be necessary to synchronize the different sensor units with one another in a certain way. There are different approaches for this purpose. To synchronize the actuators, they are regularly connected to one another via a synchronization line that is different from a line for outputting measurement data to an evaluation unit. A control signal is transmitted directly via this synchronization line and ensures that the activities of the actuators are synchronized in the desired manner. However, such designs are relatively complex to implement and are prone to errors (in particular in the case of a plurality of sensor units whose actuators are to be synchronized using a single control signal).

It is therefore an underlying object of the invention to further develop corresponding systems.

This object is satisfied by a system according to claim 1. Advantageous further developments can be seen from the dependent claims.

The system according to the invention for acquiring information on a predefined monitored zone is characterized in that each sensor unit comprises an internal clock and the times of the different sensor units are synchronized with one another. The control unit of each sensor unit is configured to perform the control of the associated actuator or actuators based on the synchronized time of the respective internal clock.

In concrete terms, this means that the actuators of the different sensor units are not (as before) controlled on the basis of a common control signal that is exchanged between the different sensor units. Rather, each sensor unit is independent per se. The control of the associated actuators in each case takes place based of an internal time of the respective sensor unit. To synchronize the actuators, the actuators (or their control units) do not exchange signals, but the times of the different sensor units are synchronized. This simultaneously offers several advantages. On the one hand, a separate and interference-prone synchronization line between the different sensor units can be omitted. On the other hand, it is particularly easily possible to add further sensor units to a given system or to remove or replace sensor units without having to modify the structural design and/or the manner of a synchronization signal of the remaining components of the system. Furthermore, when evaluating the signals of the different sensor units, it is no longer necessary to analyze and compensate for possible discrepancies between the synchronization of the actuators and different times of the system (in particular with respect to a comprehensive system time).

The different sensor units are preferably each connected to a common time synchronizer, in particular in the form of a Precision Time Protocol—PTP—server.

The time of each sensor unit is predefined directly by the common time synchronizer, independently of the other sensor units. For this purpose, no communication between the different sensor units is required or provided. Such a system can be particularly accurately, reliably and easily extended by further sensor units.

The internal clocks of the different sensor units are preferably synchronized by means of the Precision Time Protocol (PTP).

Such a synchronization is particularly precise.

Each of the sensor units preferably has an individual connection, in particular in the form of an Ethernet interface and/or a field bus interface, wherein both the synchronization of the times of the different sensor units and the output of measurement data take place via this individual connection.

This enables a particularly clear and compact overall design.

For example, fieldbus protocols, in particular Ethernet-based protocols, preferably real-time fieldbus protocols, e.g. Sercos III, EIP, EtherCAT, TSN (Time Sensitive Networking), Modbus TCP and/or ProfiNet IO, are used for communication or data transmission. For example, Sercos III could be used as the primary fieldbus protocol for transmitting measurement data. It can be combined with EIP as a secondary fieldbus protocol for time synchronization. These two fieldbus protocols can furthermore be combined with Modbus TCP as a third fieldbus protocol for commissioning applications. Thus, three different fieldbus protocols can be used side by side (e.g. simultaneously) on the same fieldbus, i.e. on the same fieldbus hardware.

The different sensor units are preferably connected to a common evaluation unit, in particular in the form of a personal computer.

This enables the central collection and the combined evaluation of the measurement data of the various sensor units.

The sensors of the sensor units are preferably optical sensors.

Optical sensors enable a simple and reliable acquisition of a wide range of information on the respective monitored zone.

The sensor units are preferably 2D or 3D laser scanners, preferably LiDAR sensors.

Such sensor units are particularly suitable for a reliable acquisition of precise spatial information on the respective monitored zone.

The control units of the different sensor units are preferably configured to control the associated actuators based on the synchronized time of the associated internal clock at a predefined phase offset relative to the actuators of the other control units.

In other words, the provided synchronization of the different actuators causes a periodic synchronization of the different actuators at a predefined phase offset. For example, the control unit of a first sensor unit controls a rotary actuator of a first sensor such that the latter faces in a first predefined direction every full second. The control unit of a second sensor unit controls a rotary actuator of a second sensor such that the latter faces in a second direction, which is opposite the first direction, every full second. This facilitates the combined evaluation of the measurement data of the different sensor units.

The different sensor units are preferably configured to output their measurement data provided with a time stamp.

This facilitates the combined evaluation of the measurement data of the different sensor units, in particular against the background of the synchronized time.

The provided actuators are preferably configured for a purely rotational variation of the orientation of the associated sensors.

Such systems are structurally simple, space-saving and robust and can also be reliably implemented.

A corresponding method for the synchronous control of actuators of at least two different sensor units comprises synchronizing the internal time of the different sensor units, in particular by means of a Precision Time Protocol (PTP); and controlling the actuators of the different sensor units based on the time of the individual sensor units that is synchronized in this way.

This results in the advantages described above.

The invention will be described purely by way of example with reference to the drawings in the following. There are shown:

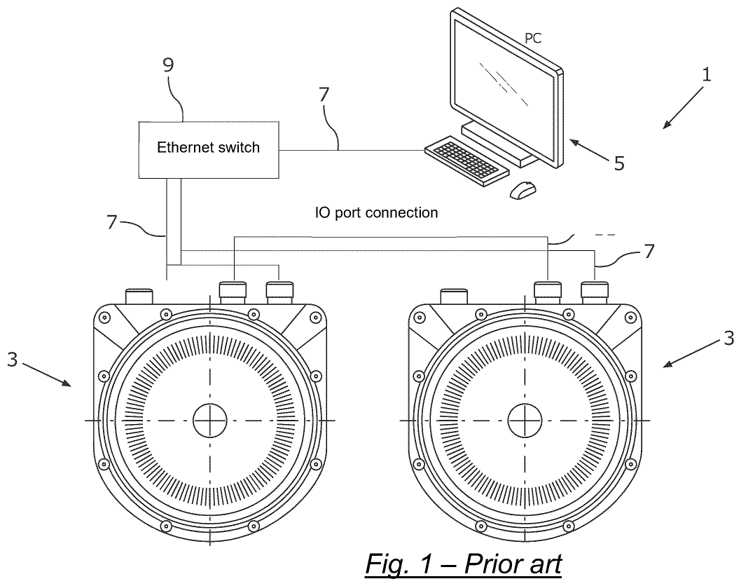

FIG. 1 schematically, an exemplary system for acquiring information on a predefined monitored zone according to the prior art; and

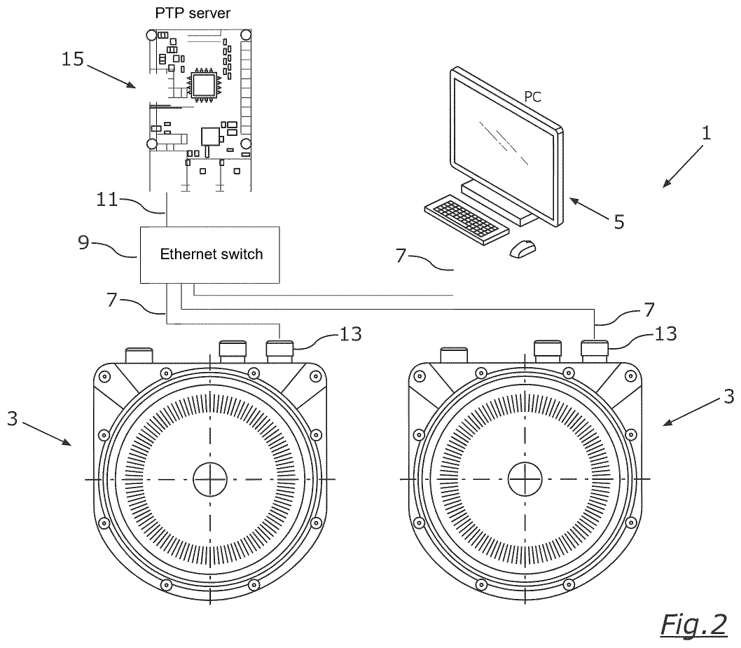

FIG. 2 schematically, an exemplary system for acquiring information on a predefined monitored zone according to the present invention.

According to FIG. 1, a conventional system 1 comprises two sensor units 3 that are connected or at least connectable to a common evaluation unit 5, in this case in the form of a personal computer. In the example shown, the two sensor units 3 are each connected via a separate data line 7 to an Ethernet switch 9. Said Ethernet switch 9 is again connected via a separate data line 7 to the evaluation unit 5.

Even if this is not explicitly shown here, each of the sensor units 3 comprises at least one sensor, at least one actuator for varying the orientation and/or position of the at least one sensor, and at least one control unit for controlling the at least one actuator.

The two sensor units 3 are connected to one another directly (i.e. not via the Ethernet switch 9) via a further provided synchronization line 11 (“IO port connection”). The two sensor units 3 can exchange a synchronization signal, in particular in the form of a control signal, via this synchronization line 11. Specifically, one of the two sensor units 3 (for example the left-hand one) can be configured as a “master sensor unit”. In this respect, the control unit of this “master sensor unit” can be configured not only to output a control signal to its own actuator, but also to output a control signal to the control unit or to the actuator of the other sensor unit 3 (in this case the right-hand one) as a “slave sensor unit”.

The synchronization of the actuators of the different sensor units 3 conventionally therefore takes place based on a direct communication between the two sensor units 3 and in particular via a synchronization line 11 specifically provided for this purpose. A conceivable synchronization of the times of the internal clocks of the two sensor units 3 takes place separately or independently of the synchronization of the actuators. Specifically, in the above example, the control of at least the actuator of the “slave sensor unit” takes place independently of an internal time of the “slave sensor unit”.

With reference to FIG. 2, in contrast to the above, a system modified according to the invention does not require a synchronization line 11 between the different sensor units 3.

As can be seen in FIG. 2, each of the sensor units 3 comprises an individual connection 13 both for synchronizing the internal clocks of said sensor units and for outputting measurement data to the common evaluation unit 5.

To synchronize the internal clocks of the different sensor units 3, in the present case, a common time synchronizer 15 in the form of a PTP server is connected via a single synchronization line 11 to the Ethernet switch 9 and, starting from this, is connected via the respective data lines 7 to the different sensor units 3. Therefore, only a single synchronization line 11 has to be provided for any desired number of sensor units.

The times of the internal clocks of the individual sensor units 3 are synchronized by means of this time synchronizer 15. The control of the actuators of the different sensor units 3 in each case takes place on the basis of the separate (synchronized) time of each of the sensor units 3, and thus effectively independently of the control of the actuators and/or of the time in the remaining sensor units 3. The synchronization of the actuators of the different sensor units thus only takes place indirectly. In this respect, it is, however, naturally desired that the time in each of the sensor units 3 corresponds to a common system time defined by the time synchronizer 15.

A particularly precise synchronization of the internal clocks of the different sensor units 3 is to be achieved via the Precision Time Protocol (PTP).

An incorrect synchronization of the time of individual sensor units 3 has no negative influence on the function of the remaining sensor units 3 due to an independent control of the actuators of the different sensor units. Furthermore, it is possible to connect further sensor units 3 to the Ethernet switch 9, to decouple sensor units 3 from the Ethernet switch 9 and/or to replace faulty sensor units 3 without having to adapt the remaining components of the system in a time-consuming manner.

The specific control of the actuators of each of the sensor units 3 in dependence on their respective own time can be specified in the control unit of each of the individual sensor units 3. The different sensor units 3 are thus preferably units that are independent per se and that, after a one-off setting or synchronization of their time and programming of their control unit, can already operate completely independently of other sensor units and/or specific input signals.

A combination and evaluation of the measurement data of the different sensor units 3 then takes place in the evaluation unit 5. To facilitate the evaluation of the measurement data and for a possible error recognition, the sensor units 3 can provide their respective measurement data with their personal time stamp.

### REFERENCE NUMERAL LIST

1 system for acquiring information on a predefined monitored zone
3 sensor unit
5 evaluation unit
7 data line
9 Ethernet switch
11 synchronization line
13 combined connection
15 time synchronizer/PTP server

1. A system for acquiring information on a predefined monitored zone, wherein the system comprises:
at least two sensor units, each having at least one sensor, at least one actuator for varying the orientation and/or position of the at least one sensor, and at least one control unit for controlling the at least one actuator,
characterized in that
each sensor unit comprises an internal clock and the times of the different sensor units are synchronized with one another; and the control unit of each sensor unit is configured to perform the control of the associated actuator or actuators based on the synchronized time of the respective internal clock.

2. The system according to claim 1,
wherein the different sensor units are each connected to a common time synchronizer, in particular in the form of a Precision Time Protocol—PTP—server.

3. The system according to claim 1,
wherein the internal clocks of the different sensor units are synchronized by means of the Precision Time Protocol.

4. The system according to claim 1,
wherein each of the sensor units has an individual connection, wherein both the synchronization of the times of the sensor units and the output of measurement data take place via this individual connection.

5. The system according to claim 4,
wherein the individual connection is respectively present in the form of an Ethernet interface and/or a field bus interface.

6. The system according to claim 1,
wherein the different sensor units are connected to a common evaluation unit.

7. The system according to claim 6,
wherein the common evaluation unit is in the form of a personal computer.

8. The system according to claim 1,
wherein the sensors of the sensor units are optical sensors.

9. The system according to claim 1,
wherein the sensor units are 2D or 3D laser scanners.

10. The system according to claim 9,
wherein the 3D laser scanners are LiDAR sensors.

11. The system according to claim 1,
wherein the control units of the different sensor units are configured to control the associated actuators based on the synchronized time of the associated internal clock at a predefined phase offset relative to the actuators of the other control units.

12. The system according to claim 1,
wherein the sensor units are configured to output their measurement data provided with a time stamp.

13. The system according to claim 1,
wherein the provided actuators are configured for a purely rotational variation of the orientation of the associated sensors.

14. A method for the synchronous control of actuators of at least two different sensor units, wherein the method comprises:
synchronizing the internal time of the different sensor units; and
controlling the actuators of the different sensor units based on the time of the individual sensor units that is synchronized in this way.

15. The method of claim 14, wherein the synchronizing of the internal time of the different sensor units is carried out by means of a Precision Time Protocol.
